(19) United States
(12) Patent Application Publication
(10) Pub. No.: US 2020/0197831 A1
(43) Pub. Date: Jun. 25, 2020

(54) QUANTITATIVE ONLINE CO2-BASED EXTRACTION

(71) Applicant: Waters Technologies Corporation, Milford, MA (US)

(72) Inventors: Jason Hill, Milford, MA (US); Abhijit Tarafder, Blackstone, MA (US); Michael O. Fogwill, Uxbridge, MA (US)

(73) Assignee: Waters Technologies Corporation, Milford, MA (US)

(21) Appl. No.: 16/718,891

(22) Filed: Dec. 18, 2019

Related U.S. Application Data
(60) Provisional application No. 62/782,603, filed on Dec. 20, 2018.

(51) Int. Cl. B01D 11/02; B01D 11/04; G01N 30/72

(52) U.S. Cl. CPC B01D 11/0203; G01N 30/7233; B01D 11/0407

(57) ABSTRACT

Exemplary embodiments are directed to methods and systems for performing online quantitative supercritical fluid extraction. An extraction cell having a known or characterized volume is loaded with a sample matrix including an analyte of interest. The extraction cell is pressurized with extraction conditions to dissolve the analyte from the sample matrix. The dissolved solution is directed from the extraction cell to a sample loop which also has a characterized volume. The dissolved solution is then directed from the sample loop to a chromatography column and subsequently to a detector. The detector output is compared against a calibration curve to determine an amount of the analyte within the sample matrix based on the known volumes of the sample loop and the extraction cell.

### CROSS-REFERENCE TO RELATED APPLICATIONS

This application claims the benefit of and priority to U.S. Provisional Patent Application No. 62/782,603 filed Dec. 20, 2018 titled “QUANTITATIVE ONLINE CO₂-BASED EXTRACTION,” the entire contents of which is hereby incorporated by reference in its entirety.

### TECHNICAL FIELD

The present disclosure relates to an extraction system and, in particular, to a quantitative online CO₂-based extraction system.

### BACKGROUND

Supercritical fluid extraction (SFE) is a process of separating components in a solid or semisolid matrix from other components in the matrix using supercritical fluids as the extracting solvent. SFE can be performed by passing an extracting solvent, such as compressed CO₂, through an extraction vessel filled with a packed matrix. The output of the extraction vessel can be directed to a trap column, in some cases, before diverting the contents of the trap column to a chromatography column for chromatographic analysis. This technique can be challenging, however, because it may be difficult to identify an appropriate trap to efficiently capture all the analyte from the mobile phase that was used for the extraction.

### SUMMARY

Performing online quantitative fluid extraction poses a number of challenges. Diverting the output of an extraction column to a trap column upstream of a chromatography column can pose challenges, because it may be difficult to identify an appropriate trap to efficiently capture all the analyte from the mobile phase that was used for the extraction. In general, certain embodiments of the present technology feature an extraction cell and a sample loop which each have a characterized or known volume. These known volumes facilitate online quantitative fluid extraction without the need for a separate trap column.

In one aspect, the present technology relates to a method for quantitative online fluid extraction. The method includes loading a substantially negligible volume of an extraction cell having a characterized volume with a sample matrix including an analyte of interest; bringing the extraction cell to target extraction conditions; and dissolving the analyte of interest in an extraction fluid to generate a dissolved solution. The method also includes homogenizing a concentration of the dissolved analyte within the extraction cell. The method also includes directing the dissolved solution to a sample loop having a characterized volume within a second valve. The method also includes directing the dissolved solution from the sample loop to a chromatography column. The method also includes directing an output from the chromatography column to a detector. The method also includes comparing a detector output against a calibration curve to determine an amount of the analyte of interest within the sample matrix. In a non-limiting example, the method also includes generating the calibration curve using an autosampler by performing a chromatographic injection with a known quantity of the analyte of interest in order to generate a detection response. In another non-limiting example, the method also includes calculating a mass of the analyte directed through the chromatography column based on the calibration curve; calculating a concentration of the analyte within the sample matrix solution based on the characterized volume of the sample loop; and calculating the amount of analyte within the sample matrix solution based on the concentration and the characterized volume of the extraction cell. In another non-limiting example, the extraction cell is a component of a CO₂-based extraction system. In another non-limiting example, the first valve or the second valve can be a rotary valve. In another non-limiting example, the method also includes pressurizing the extraction cell after the sample matrix has been loaded within the extraction cell. In another non-limiting example, the method also includes isolating the extraction cell from the chromatography column after pressurizing the extraction cell; and matching a pressure of the first valve and the second valve with the chromatography column if the starting conditions of the chromatography column are not compatible with the extraction cell.

In another aspect, the present technology relates to a system for performing quantitative online CO₂-based extraction. The system includes an extraction cell having a characterized volume and configured to hold a sample matrix including an analyte of interest. The system also includes a first valve configured to selectively direct an extraction fluid to the extraction cell. The system also includes a second valve having a sample loop with a characterized volume in fluid communication with the extraction cell. The system also includes a CO₂-based chromatography column in fluid communication with the second valve and configured to selectively receive fluid from the sample loop. The system also includes a detector in fluid communication with the second valve and configured to selectively receive fluid from either the extraction cell or the chromatography column through the second valve. In a non-limiting example, the first valve or the second valve can be a rotary valve. In another non-limiting example, the system also includes a processing unit configured to control an operation of the first valve and the second valve in order to selectively direct the sample matrix solution from the extraction cell, through the sample loop, and to the chromatography column.

In another aspect, the present technology relates to a method for quantitative online CO₂-based extraction. The method includes switching a first valve and a second valve from a first position to a second position configured to direct a majority of a sample matrix solution to a chromatography column via the second valve and a remaining portion of the sample matrix solution to an extraction cell via the first valve, wherein the extraction cell is isolated from the chromatography column when the first valve and second valve are in the first position. The method also includes switching the first valve and the second valve to a third position to direct the contents of the extraction cell to a sample loop within the second valve, wherein the extraction cell and the sample loop each have a known volume. The method also includes switching the first valve and the second valve to the first position to direct the contents of the sample loop to the chromatography column. The method also includes directing the output from the chromatography column to a detector. The method also includes determining an amount of an analyte within the sample matrix solution based on a comparison of a detector response against a calibration curve corresponding to the analyte. In a non-limiting example, the method also includes generating the calibration curve using an autosampler by performing a chromatographic injection with a known quantity of the analyte of interest in order to generate a detection response. In another non-limiting example, the method also includes calculating a mass of the analyte directed through the chromatography column based on the calibration curve; calculating a concentration of the analyte within the sample matrix solution based on the characterized volume of the sample loop; and calculating the amount of analyte within the sample matrix solution based on the concentration and the characterized volume of the extraction cell. In another example embodiment, the extraction cell is a component of a CO₂-based extraction system. In another non-limiting example, the first valve or the second valve can be a rotary valve. In another non-limiting example, the method also includes pressurizing the extraction cell when the first valve and the second valve are in the second position. In another non-limiting example, the method also includes switching the first valve and the second valve to the first position to isolate the extraction cell from the chromatography column after pressurizing the extraction cell; and matching a pressure of the first valve and the second valve with the chromatography column if the starting conditions of the chromatography column are not compatible with the extraction cell.

The above aspects of the technology provide numerous advantages. For example, the techniques described herein eliminate the need for a trap column when performing quantitative online extraction. The trap column is not necessary because the analyte can be fully dissolved within the extraction cell and then passed through a sample loop which both have a known or characterized volume.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is a cross-sectional side view of an exemplary extraction cell with a characterized volume, in accordance with an embodiment of the present disclosure.

FIG. 1B is an example extraction profile of an analyte leaving the cell of FIG. 1, according to an embodiment of the present disclosure.

FIG. 1C shows an example switching valve including a sample loop with a characterized volume, in accordance with an embodiment of the present disclosure.

FIG. 2 is an example block diagram of an extraction system in a first position, according to an embodiment of the present disclosure.

FIG. 3 is an example block diagram of the extraction system of FIG. 2 in a second position, according to an embodiment of the present disclosure.

FIG. 4 is an example block diagram of the extraction system of FIG. 2 in a third position, according to an embodiment of the present disclosure.

FIG. 5 is an example flowchart of a method for performing quantitative online extraction, in accordance with an embodiment of the present disclosure.

FIG. 6 shows an example system that can be used to perform example processes and computations, according to principles of the present disclosure.

### DESCRIPTION OF EXEMPLARY EMBODIMENTS

In general, the present technology is related to an extraction system having an extraction cell or extraction vessel with a characterized volume. The extraction cell can also be in fluid communication with a valve having a sample loop with a characterized volume as well. Extraction vessels are generally packed with a matrix and an extracting solvent is passed through the extraction vessel to extract substances from the packed matrix. The present technology also relates to a method for performing fluid extractions, such as CO₂-based extractions, coupled to a chromatographic apparatus for quantitative online analysis. The method and system can involve, for example: an extraction system capable of static and dynamic extraction conditions; an extraction cell with a characterized volume and containing a sample that occupies a negligible amount of space in the extraction cell; a sample loop with characterized volume downstream of the extraction cell; and a chromatographic system with a sample loop with characterized volume.

The present disclosure may also include an apparatus or stirring component to agitate or homogenize the sample in the extraction cell, in some embodiments. In some non-limiting examples, the chromatographic system may or may not have common components to the extraction system, and the online sample loop may or may not be the same sample loop used in the chromatographic system.

For quantitative analysis, all of the analyte of interest can be separated from the sample matrix and transferred into the mobile phase during the extraction process. According to conventional techniques, the mobile phase containing the analyte usually flows into a trap column in order to refocus the analyte before the chromatographic analysis. The chromatographic conditions are then used to elute the analyte off the trap and onto the chromatographic column. As discussed above, this methodology can be challenging because it may be difficult to identify an appropriate trap to efficiently capture all the analyte from the mobile phase that was used for the extraction.

With the methods and systems disclosed herein, the need for a trap column when performing quantitative online extraction can be eliminated because the analyte gets fully dissolved in an extraction cell with known volume and then positioned onto a sample loop with characterized/known volume.

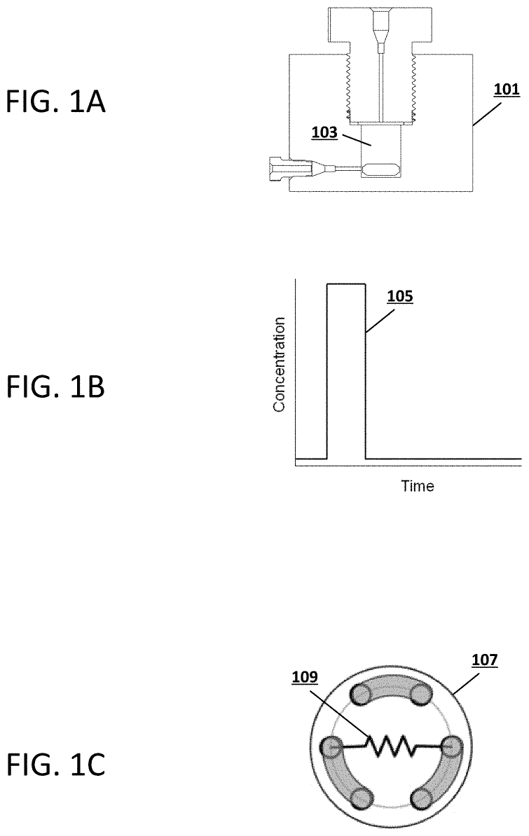

FIG. 1A is a cross-sectional side view of an exemplary extraction cell 101 with a characterized volume, in accordance with an embodiment of the present disclosure. In a non-limiting example, the extraction cell 101 can include an internal chamber 103 where a sample matrix can be placed or loaded. This sample chamber 103 can have a known or characterized volume such that the final mass of an analyte within the sample matrix can be better calculated. In the proposed process, the customary fully packed extraction cell can be replaced with an extraction cell 101 configured to house or hold a sample matrix within a sample chamber 103. In some embodiments, the extraction cell 101 may be equipped to include a mixing or stirring mechanism to agitate or homogenize the sample. A small sample amount can be added to the extraction cell 101 taking up a negligible amount of the space within the extraction chamber 103. The extraction cell 101 can then be pressurized with the appropriate extraction conditions and held statically in order to dissolve all the analyte of interest. The sample can be agitated, in some embodiments, to promote efficient extraction time and to equally distribute the concentration within the body of the cell. When flow is diverted through the cell, a portion of fluid with a substantially equal analyte concentration flushes out of the cell.

FIG. 1B is an example extraction profile of an analyte leaving the cell of FIG. 1, according to an embodiment of the present disclosure. As mentioned above, when flow is directed through the characterized extraction cell 101 an extraction profile having a peak 105 analyte concentration is generated. This extraction profile represents the concentration of analyte exiting the characterized extraction cell 101, and the width of the square wave peak 105 represents the time required to flush the extraction cell 101. This square wave peak 105 represents the analyte concentration that should be trapped onto the sample loop and subsequently directed to a chromatography column.

FIG. 1C shows an example switching valve 107 including a sample loop 109 with a characterized volume, in accordance with an embodiment of the present disclosure. In this non-limiting example, the known volume of the extraction cell 101 and the known volume of the sample loop 109 of the switching valve 107 allow for a comparison of the chromatographic response of the square wave peak 105 against a calibration curve. This comparison can provide a calculation of the concentration of the analyte within the extraction cell, and thus the amount or mass of the analyte in the extraction sample.

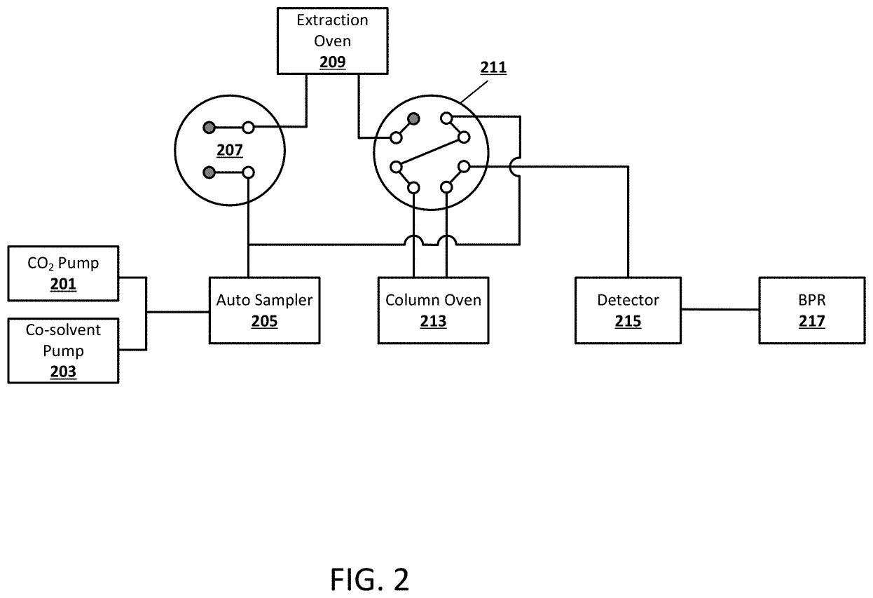

FIG. 2 is an example block diagram of an extraction system in a first position, according to an embodiment of the present disclosure. In this first position, the extraction oven 209, which contains the extraction cell in this example embodiment, is offline or isolated from the rest of the system. This is because the first valve 207 and the second valve 211 are positioned to isolate the extraction oven 209. In a non-limiting example, the first valve 207 and the second valve 211 can be rotary valves. While the extraction oven 209 is offline, the rest of the system can continue to operate independently of the extraction oven 209. In a non-limiting example, the system is a CO₂-based system that also includes a CO₂ pump 201, a co-solvent pump 203, an auto sampler 205 connected to the first valve 207, a column oven 213 containing a chromatography column connected to the second valve 211, a detector 215 also connected to the second valve 211, and a BPR 217 located downstream of the detector 215. In the first position, the entirety of the mobile phase travels from the pumps 201, 203 into the auto sampler 205, into the second valve 211, through the column oven 213, and into the detector 215 and BPR 217 via the second valve 211.

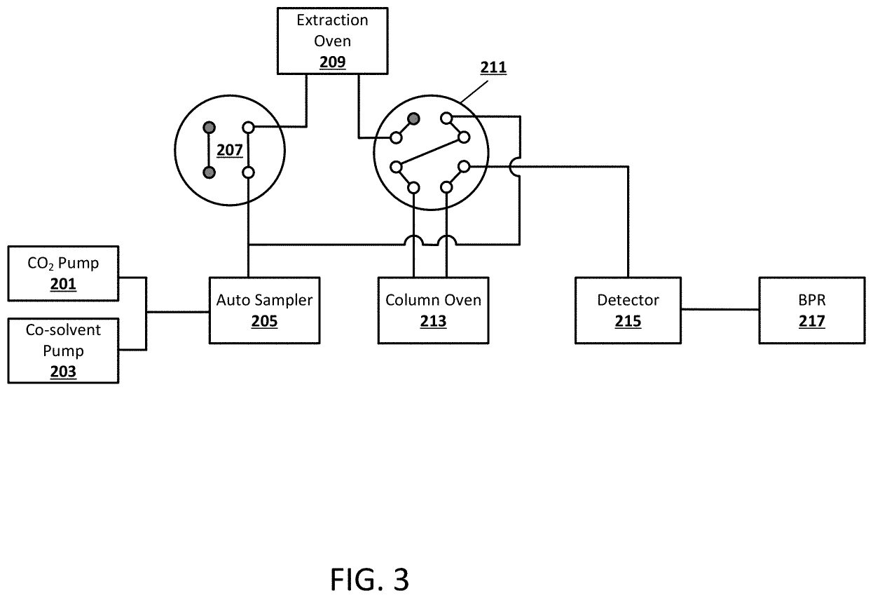

FIG. 3 is an example block diagram of the extraction system of FIG. 2 in a second position, according to an embodiment of the present disclosure. In the second position shown in FIG. 3, because the second valve 211 does not connect the extraction oven 209 to any output, a majority of the mobile phase travels from the pumps 201, 203 into the auto sampler 205, into the second valve 211, and to the column oven 213. In a non-limiting example, the output of the column oven 213 can be directed to the detector 215 and the BPR 217 via the second valve 211. When set to the second position, the first valve 207 can be configured to direct a portion of the mobile phase into the extraction oven 209, in some embodiments. In a non-limiting example, the partial flow diverted to the extraction oven 209 is pressurized and equilibrated within the extraction cell.

In some embodiments, the system switches back to the first position shown in FIG. 2 to isolate the extraction oven 209 once it is pressurized. This isolation step can allow the remainder of the system to be equilibrated with the chromatographic method. If, however, the starting conditions of the chromatographic method are the same as or compatible with the extraction conditions of the extraction cell, this step could be omitted.

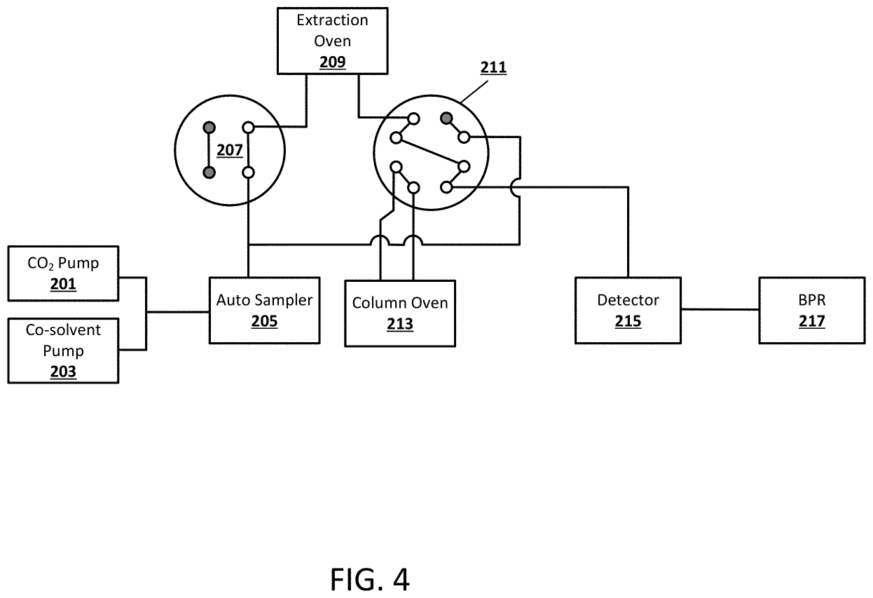

FIG. 4 is an example block diagram of the extraction system of FIG. 2 in a third position, according to an embodiment of the present disclosure. In the third position shown in FIG. 4, the entirety of the mobile phase flow travels from the pumps 201, 203 into the auto sampler 205, and into the extraction oven 209 via the first valve 207. The mobile phase can then flow from the extraction oven 209, into the second valve 211 having the sample loop or trap, and to the detector 215 and BPR 217. In this example embodiment, the entire mobile phase flow is diverted through the extraction oven 209 in order to push the concentrated sample out of the extraction cell and into the characterized sample loop in the second valve 211, which is then directed to the detector 215. In a non-limiting example, the system can be switched to the third position shown in FIG. 4 for just enough time so that the concentrated sample can pass into the characterized sample loop within the second valve 211. Once the concentrated sample is contained within the characterized sample loop within the second valve, the first valve 207 and the second valve 211 can be switched once again to the first position shown in FIG. 2 in order to direct the contents of the sample loop into the chromatographic column within the column oven 213. In a non-limiting example, this switching can be performed rapidly in order to direct the characterized sample peak, represented by the square wave in FIG. 1B, to the column oven 213 and the detector 215. The chromatographic response from the detector 215 can then be compared against a calibration curve in order to determine the amount of the analyte within the matrix.

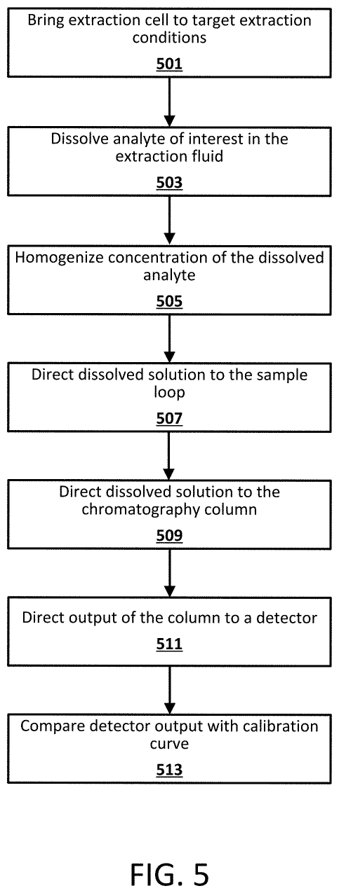

FIG. 5 is an example flowchart of a method for performing quantitative online extraction, in accordance with an embodiment of the present disclosure. In step 501, the extraction cell is brought to target extraction conditions. In step 503, the analyte of interest is dissolved within the extraction fluid to form a dissolved solution. In a non-limiting example, the extraction cell having the characterized volume is loaded with a sample that occupies a negligible amount of space in the extraction cell. This step can be performed while the system and valves are in the first position, as described in FIG. 2 above.

In step 505, the concentration of the dissolved analyte within the dissolved solution is homogenized. As discussed above, the extraction cell may be equipped to include a mixing or stirring mechanism to agitate or homogenize the contents of the extraction cell.

In step 507, the dissolved solution containing the dissolved analyte is directed from the characterized extraction cell into the sample loop, which also has a characterized volume. In a non-limiting example, this step can be performed while the system and valves are in the third position, as described in FIG. 4 above. In this step, the fluid from the extraction cell is directed to the sample loop within the second valve 211.

In step 509, the dissolved solution is directed from the sample loop to the chromatography column. In a non-limiting example, this step can be performed while the system and valves are in the first position, as described in FIG. 2 above. In this step, the fluid from the sample loop within the second valve 211 is directed to the chromatography column. The operation of the second valve 211 can be performed such that the peak concentration of the analyte, as shown above in FIG. 1B, is directed to the chromatography column.

In step 511, the output of the column is directed to the detector. In step 513, the output of the detector can be compared against a calibration curve. Using the calibration curve, which provides a known detection response for the analyte, one can calculate the mass of the analyte that was directed through the chromatography column and the detector. This mass value of the analyte, combined with the known volume of the sample loop in the second valve 211, provides a concentration of the analyte within the fluid or mobile phase. Knowing this concentration, along with the known volume of the extraction cell, can then provide the mass of the analyte initially within the extraction cell. In a non-limiting example, the calibration curve can be generated using an autosampler by performing a chromatographic injection with a known quantity of the analyte of interest in order to generate a detection response. In another example, the detector output can be compared against a standard or set of standards at step 513, rather than a generated calibration curve. This detection response can be compared against any detector data generated during the online analysis.

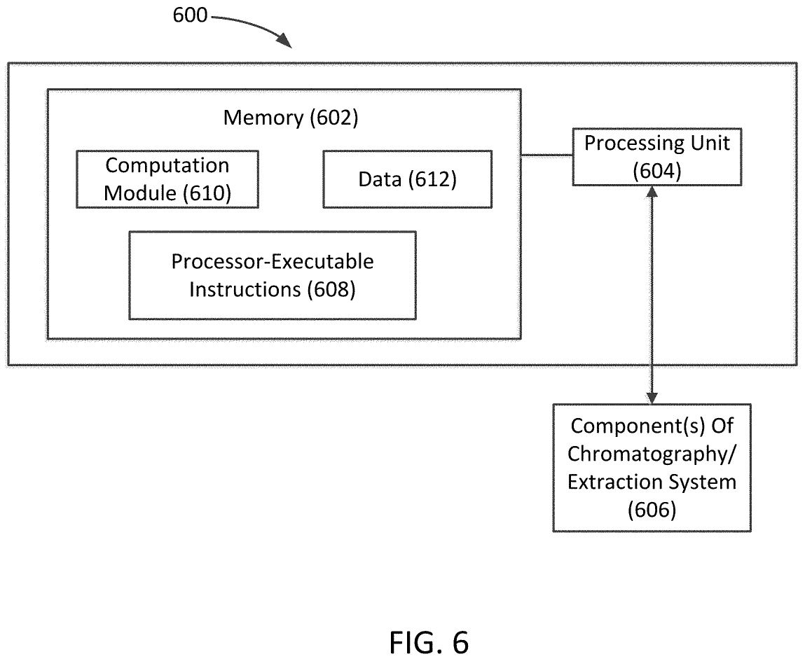

FIG. 6 shows a non-limiting example system 600 that can be used to implement an example method for quantitative online extraction, according to the principles described herein. The system 600 can include at least one memory 602 and at least one processing unit 604. The processing unit 604 can be communicatively coupled to the memory 602 and also to at least one component of a chromatography/extraction system 606, such as the valves, pumps, or other components described herein.

The memory 602 can be configured to store processor-executable instructions 608 and a computation module 610. In an example method, as described in connection with FIGS. 2-5, the processing unit 604 can execute processor-executable instructions 608 stored in the memory 602 to control the operation of the valves and/or the pumps in order to operate the valves in the first, second, or third positions described above.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method for quantitative online fluid extraction, comprising:
loading a substantially negligible volume of an extraction cell having a characterized volume with a sample matrix including an analyte of interest;
bringing the extraction cell to target extraction conditions;
dissolving the analyte of interest in an extraction fluid to generate a dissolved solution;
homogenizing a concentration of the dissolved analyte within the extraction cell;
directing the dissolved solution to a sample loop having a characterized volume within a second valve;
directing the dissolved solution from the sample loop to a chromatography column;
directing an output from the chromatography column to a detector; and
comparing a detector output against a calibration curve to determine an amount of the analyte of interest within the sample matrix.

2. The method of claim 1, further comprising:
generating the calibration curve using an autosampler by performing a chromatographic injection with a known quantity of the analyte of interest in order to generate a detection response.

3. The method of claim 1, further comprising:
calculating a mass of the analyte directed through the chromatography column based on the calibration curve;
calculating a concentration of the analyte within the sample matrix solution based on the characterized volume of the sample loop; and
calculating the amount of analyte within the sample matrix solution based on the concentration and the characterized volume of the extraction cell.

4. The method of claim 1, wherein the extraction cell is a component of a CO₂-based extraction system.

5. The method of claim 1, wherein the first valve is a rotary valve.

6. The method of claim 1, wherein the second valve is a rotary valve.

7. The method of claim 1, further comprising:
pressurizing the extraction cell after the sample matrix has been loaded within the extraction cell.

8. The method of claim 7, further comprising:
isolating the extraction cell from the chromatography column after pressurizing the extraction cell; and
matching a pressure of the first valve and the second valve with the chromatography column if the starting conditions of the chromatography column are not compatible with the extraction cell.

9. A system for performing quantitative online CO₂-based extraction, the system comprising:
an extraction cell having a characterized volume and configured to hold a sample matrix including an analyte of interest;
a first valve configured to selectively direct an extraction fluid to the extraction cell;
a second valve having a sample loop with a characterized volume in fluid communication with the extraction cell;
a CO₂-based chromatography column in fluid communication with the second valve and configured to selectively receive fluid from the sample loop; and
a detector in fluid communication with the second valve and configured to selectively receive fluid from either the extraction cell or the chromatography column through the second valve.

10. The system of claim 9, wherein the first valve is a rotary valve.

11. The system of claim 9, wherein the second valve is a rotary valve.

12. The system of claim 9, further comprising a processing unit configured to control an operation of the first valve and the second valve in order to selectively direct the sample matrix solution from the extraction cell, through the sample loop, and to the chromatography column.

13. A method for quantitative online CO₂-based extraction, comprising:
switching a first valve and a second valve from a first position to a second position configured to direct a majority of a sample matrix solution to a chromatography column via the second valve and a remaining portion of the sample matrix solution to an extraction cell via the first valve, wherein the extraction cell is isolated from the chromatography column when the first valve and second valve are in the first position;
switching the first valve and the second valve to a third position to direct the contents of the extraction cell to a sample loop within the second valve, wherein the extraction cell and the sample loop each have a known volume;
switching the first valve and the second valve to the first position to direct the contents of the sample loop to the chromatography column;
directing the output from the chromatography column to a detector; and
determining an amount of an analyte within the sample matrix solution based on a comparison of a detector response against a calibration curve corresponding to the analyte.

14. The method of claim 13, further comprising:
generating the calibration curve using an autosampler by performing a chromatographic injection with a known quantity of the analyte of interest in order to generate a detection response.

15. The method of claim 13, further comprising:
calculating a mass of the analyte directed through the chromatography column based on the calibration curve;
calculating a concentration of the analyte within the sample matrix solution based on the characterized volume of the sample loop; and
calculating the amount of analyte within the sample matrix solution based on the concentration and the characterized volume of the extraction cell.

16. The method of claim 13, wherein the extraction cell is a component of a CO₂-based extraction system.

17. The method of claim 13, wherein the first valve is a rotary valve.

18. The method of claim 13, wherein the second valve is a rotary valve.

19. The method of claim 13, further comprising:
pressurizing the extraction cell when the first valve and the second valve are in the second position.

20. The method of claim 19, further comprising:
switching the first valve and the second valve to the first position to isolate the extraction cell from the chromatography column after pressurizing the extraction cell; and
matching a pressure of the first valve and the second valve with the chromatography column if the starting conditions of the chromatography column are not compatible with the extraction cell.
